(19) United States
(12) Patent Application Publication
(10) Pub. No.: US 2016/0255622 A1
(43) Pub. Date: Sep. 1, 2016

(54) APPARATUSES AND METHODS FOR EXCHANGE OF SIGNALING INFORMATION IN COMP

(71) Applicant: ALCATEL LUCENT, Boulogne-Billancourt (FR)

(72) Inventors: Zhilan Xiong, Shanghai (CN); Min Zhang, Swindon (GB); Jun Wang, Shanghai (CN); Nan Hao, Shanghai (CN); Huan Sun, Shanghai (CN); Yuwen Pan, Shanghai (CN)

(73) Assignee: Alcatel Lucent, Boulogne Billancourt (FR)

(21) Appl. No.: 15/032,975

(22) PCT Filed: Oct. 28, 2014
(86) PCT No.: PCT/IB2014/002613

§ 371 Date: Apr. 28, 2016

(30) Foreign Application Priority Data
Nov. 1, 2013 (CN) 201310534900.X

(51) Int. Cl. H04W 72/04; H04B 7/06; H04B 7/02

(52) U.S. Cl. CPC H04W 72/0426; H04B 7/024; H04B 7/063; H04B 7/0639

(57) ABSTRACT

The present invention relates to apparatuses and methods for exchange of signaling information in coordinated multi-point (CoMP). Partial embodiments of the present invention provide a method for exchange of signaling information in CoMP, where a first transmission point and a second transmission point provide CoMP for at least one user equipment (UE). The method includes: the first transmission point determining resource allocation for at least one of the first transmission point and the second transmission point, that is, the first transmission point notifying the second transmission point of the determined resource allocation. The resource allocation includes at least one of beamforming, power, and UE scheduling of the corresponding transmission point. The present invention can support CoMP under practical network conditions more effectively.

### BACKGROUND OF THE INVENTION

1. Field of the Invention

The present invention relates to signaling technologies in wireless communications, and in particular, to apparatuses and methods for exchange of signaling information in coordinated multi-point (CoMP).

2. Description of the Prior Art

CoMP transmission is a promising technology in the Long Term Evolution-Advanced (LTE-Advanced) project, and can effectively reduce Inter-Cell Interference (ICI) and improve the high data speed coverage, cell edge throughput and/or system throughput. As coordinated scheduling/beamforming (CS/CB) does not require data sharing between multiple transmission points (TPs), which thus is considered to be a technical solution that is most likely to be implemented in multi-base-station coordination based on X2 signaling. In beamforming, pre-codes on a transmitting side applied to downlink transmission coordinate between TPs to reduce interference between coverage areas of different TPs. In CS, to reduce interference, transmit power and resource allocation are coordinated.

Typically, CS/CB requires close coordination and synchronous resolution between base stations in a cooperating cluster, for example, evolved node bases (eNBs). However, for a practical network, the circuit is not optimal and there is usually a delay about 15 to 60 milliseconds. The delay may affect coordination efficiency of the CS/CB, and greatly challenges CS/CB designs.

To sum up, in consideration of a delay, an X2 interface through which signaling information is exchanged between base stations should provide robust information that can help the base stations to cooperate to make a resolution that is proper and beneficial for an entire network. Therefore, there is an urgent need for improved X2 signaling.

### SUMMARY OF THE INVENTION

Embodiments of the present invention provide apparatuses and methods for exchange of X2 signaling information, which are applicable to practical networks having delays.

An embodiment of the present invention provides a method for exchange of signaling information in CoMP, where a first transmission point and a second transmission point provide CoMP for at least one user equipment (UE). The method includes: the first transmission point determining resource allocation for at least one of the first transmission point and the second transmission point, that is, the first transmission point notifying the second transmission point of the determined resource allocation. The resource allocation includes at least one of beamforming, power, and UE scheduling of the corresponding transmission point.

In some other embodiments of the present invention, the method further includes: the first transmission point notifying the second transmission point of resource allocation for the other transmission point. The first transmission point uses an indicator of a different type of resource to notify allocation information for the type of resource, the indicator of the different type of resource including an index list of the corresponding type of resource and a corresponding bitmap. Granularity of the bitmap may be a frequency-domain physical resource block, sub-band, broadband or carrier, and/or a time-domain sub-frame. In addition, the value of each position in the corresponding bitmap may be a tag of indexes of one group of the type of resources in the index list of the corresponding type of resource. In partial embodiments, beam information corresponds to each basic unit in a corresponding beam index list, which may be related to a precoding matrix indicator (PMI), a rank indicator (RI) and a beam tag, and/or related to multiple PMI-RI pairs and a beam tag. Each beam indicator in a beam index list includes at least one beam constraint or beam permission. Beam information about the beamforming includes: 1) one or more beam indexes in a codebook, and one or more of the following information: the number of antenna ports, the number of ranks, a codebook constraint, a combined beam of a first codebook or the first codebook and a second codebook, an antenna pattern, a channel state information (CSI) process index of the corresponding transmission point, a CSI-reference signal (CSI-RS) configuration index of the corresponding transmission point, and a CSI-interference measurement (CSI-IM) configuration index of the corresponding transmission point; or 2) one or more specific beams. According to partial embodiments of the present invention, when the resource allocation of the corresponding transmission point is power, transmit power of the corresponding transmission point is reduced to a certain threshold in a selected physical resource block. When the resource allocation of the corresponding transmission point is UE scheduling, the corresponding transmission point is instructed to permit or avoid scheduling of a selected UE on a selected physical resource block/sub-frame. In some embodiments, the method further includes: in a frequency domain, compressing the signaling information by using a large sub-band size for information exchange, and in a time domain, using a timer or a time limit to indicate an effective period of the resource allocation. In some other embodiments, the method further includes: receiving resource usage information fed back by the second transmission point, and determining the resource allocation of the corresponding transmission point based on the resource usage information.

Some embodiments of the present invention further provide a method for exchange of signaling information in CoMP, where a first transmission point and a second transmission point provide CoMP for at least one UE. The method includes: the second transmission point determining resource usage information of the second transmission point; and the second transmission point reporting the determined resource usage information to the first transmission point.

In some embodiments of the present invention, the method further includes: the second transmission point reporting level information of interference to the first transmission point. The resource usage information includes: usage information about resources protected by the first transmission point, usage information about resources not protected by the first transmission point, usage information about resources protected by other neighboring cells, and usage information about resources not protected by the other neighboring cells. The second transmission point may report the resource usage information periodically or in an event-triggered manner. The resource usage information is classified into: usage of downlink physical resource blocks of protected resources for protected UEs, usage of downlink physical resource blocks of unprotected resources for the protected UEs, usage of uplink physical resource blocks of the protected resources for the protected UEs, and usage of uplink physical resource blocks of the unprotected resources for the protected UEs.

Some other embodiments of the present invention provide an apparatus for exchange of signaling information in CoMP, where a first transmission point and a second transmission point provide CoMP for at least one UE. The apparatus may be arranged on the first transmission point, and includes: a resource allocation determination device that determines resource allocation for at least one of the first transmission point and the second transmission point; and a resource allocation transmitter that notifies the second transmission point of the determined resource allocation. The resource allocation includes at least one of beamforming, power, and UE scheduling of the corresponding transmission point.

Some embodiments of the present invention provide another apparatus for exchange of signaling information in CoMP, where a first transmission point and a second transmission point provide CoMP for at least one UE. The apparatus may be arranged on the second transmission point, and includes: a resource usage information determination device that determines resource usage information of the second transmission point; and a resource usage information transmitter that reports the determined resource usage information to the first transmission point.

Correspondingly, the present invention can support CoMP under practical network conditions more effectively.

### BRIEF DESCRIPTION OF THE DRAWINGS

FIG. 1 is a flow chart of a method for exchanging signaling information in CoMP according to an embodiment of the present invention;

FIG. 2 is a schematic structural diagram of a system for exchanging signaling information in CoMP according to an embodiment of the present invention;

FIG. 3 is a flow chart of a method for exchanging signaling information in CoMP according to another embodiment of the present invention; and

FIG. 4 is a schematic structural diagram of an apparatus for exchanging signaling information in CoMP according to an embodiment of the present invention.

### DETAILED DESCRIPTION

Detailed description about the accompanying drawings intends to serve as description about preferred embodiments of the present invention, instead of representing only forms in which the present invention could be achieved. It should be understood that the same or equivalent functions can be accomplished by different embodiments intending to be covered in the spirit and scope of the present invention.

Currently, signaling for CS is transmitted in a broadcast manner, and known signaling includes relative narrowband transmit power (RNTP), an overload indicator (PO), and a high interference indicator (HII). In such signaling, a bitmap of each physical resource block (PRB) in a corresponding frequency domain indicates a relative downlink transmit power level by means of RNTP, indicates a relative uplink transmit power level by means of HII, and indicates a relative uplink interference level by means of OI. In view of long or short delays of nonoptimal circuits in exchange of signaling information, centralized scheduling might not work. Therefore, signaling of the RNTP, OI and HII constrains downlink and uplink cooperative information.

The present invention provides a feasible technical solution that supports CS/CB within a constraint of a nonoptimal circuit, which is applicable to distributed scheduling or centralized-control scheduling, and solves the above technical problem.

In a CoMP system according to an embodiment of the present invention, a first transmission point and at least one second transmission point provide CoMP for at least one UE. From the perspective of a CS/CB, the UE is served by the first transmission point unless the UE is switched to the second transmission point. That is, the UE is affiliated to or served by the first transmission point, the first transmission point is a service transmission point of the UE, and the second transmission point is a neighboring transmission point of the UE.

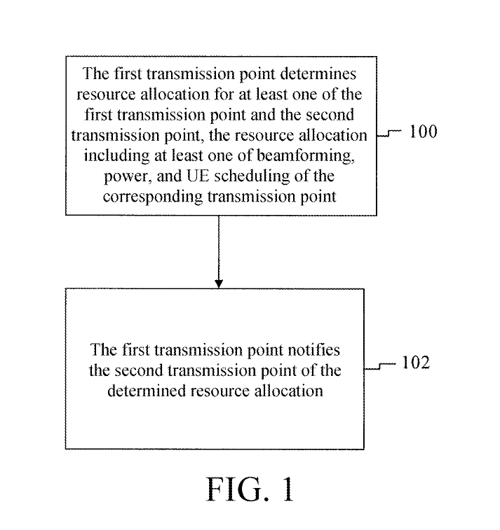

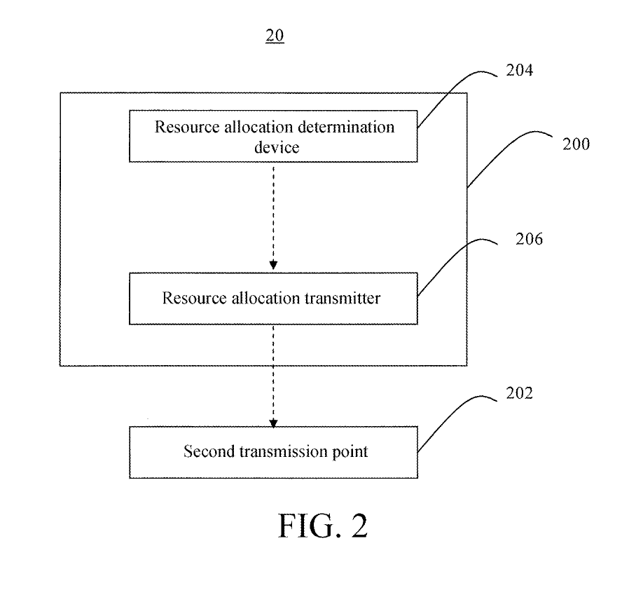

In CoMP, exchange of signaling information between TPs can be accomplished through X2 signaling. The X2 signaling according to the embodiments of the present invention can be used to exchange information to recommend the second transmission point to avoid some downlink scheduling resolutions for the interests of the first transmission point. FIG. 1 is a flow chart of a method for exchanging signaling information in CoMP according to an embodiment of the present invention, and FIG. 2 is a schematic structural diagram of a system 20 for exchanging signaling information in CoMP according to an embodiment of the present invention, where an apparatus 200 may be arranged on the first transmission point or may be the first transmission point. In this embodiment, it is set that the apparatus 200 is the first transmission point.

As shown in FIG. 1 and FIG. 2, the method includes: In step 100, the apparatus 200, that is, a resource allocation determination device 204 of the first transmission point, determines resource allocation for at least one of the first transmission point 200 and the second transmission point 202, the resource allocation including at least one of beamforming, power, and UE scheduling of the corresponding transmission point, that is, the first transmission point 200 or the second transmission point 202. In step 102, a resource allocation transmitter 206 of the apparatus 200 notifies the second transmission point 202 of the determined resource allocation. According to partial embodiments of the present invention, the first transmission point 200 uses an indicator of a different type of resource to notify the second transmission point 202 of allocation information for the type of resource of the corresponding transmission point, the indicator of the different type of resource including an index list of the corresponding type of resource and a corresponding bitmap. For example, the first transmission point 200 uses a beam indicator to notify the second transmission point 202 of beam information thereof, the beam indicator including a beam index list and a corresponding bitmap, or uses a power indicator to notify the second transmission point 202 of power information of the second transmission point 202, the power indicator including a power index list and a corresponding bitmap.

Specifically, by taking resource allocation of the first transmission point 200 as an example, possible cooperative information transmitted by the X2 signaling according to partial embodiments of the present invention includes all or part of the following information.

Spatial Domain

According to partial embodiments of the present invention, the first transmission point 200 notifies that the beam indicator of the second transmission point 202 may indicate one or more beams. The one or more beams may be avoided or used by the first transmission point 200. The beam information may include:
1) one or more beam indexes in a codebook and one or more of the following information:

A. the number of antenna ports

B. the number of ranks

C. a codebook constraint, which can use a codebook constraint mode for a CSI report configuration

D. a combined beam of a first codebook or the first codebook and a second codebook, where the codebook may be a precoding codebook from a UE to the first transmission point 200 or other newly-defined codebooks, and a non-two-stage codebook can be considered to have only one first codebook

E. an antenna pattern, for example, a uniform linear array or an arc-shaped linear array

F. a CSI process index of the first transmission point 200

H. a CSI-RS configuration index of the first transmission point 200

I. a CSI-IM configuration index of the first transmission point 200
2) one or more specific beams.

In some embodiments of the present invention, the beams can be sub sampled to reduce an overhead of signaling information and improve robustness for delays of the nonoptimal circuit, and can also be associated with an adjustment coefficient, for example, a power constraint.

The beam information can be sent to the second transmission point 202 by the first transmission point 200 by means of a beam indicator, that is, a beam index list and a corresponding bitmap. Each beam indicator may include at least one beam constraint (avoidable beam) or beam permission (useable beam).

The beam information corresponds to each basic unit in the beam index list, and can be related to a PMI, an RI, and a beam tag, and/or related to multiple PMI-RI pairs and a beam tag. In partial embodiments of the present invention, the value of each position in the bitmap indicates whether a beam or a group of beams is constrained. In some other embodiments of the present invention, the value of each position in the bitmap indicates whether a beam or a group of beams is permitted. The value of each position in the bitmap may have a number of expression manners, for example, in partial embodiments of the present invention, the value of each position in the bitmap may be a tag of a beam index in the list. When indicating a beam constraint, “0” indicates that there is no beam constraint, “1” indicates that a beam indicated by the lowest tag in a beam index is constrained, and “2” indicates that a beam indicated by the second lowest tag in the beam index is constrained, and so on. In other embodiments, when indicating a beam constraint, “0” indicates that there is no beam constraint, and “1” indicates that a beam indicated by a tag with “x” in the beam index is constrained.

In partial embodiments of the present invention, when the value of each position in the bitmap may be a tag of indexes of one group of beams in the list, group indications need to be additionally exchanged. Similarly, when indicating a beam constraint, “0” indicates that there is no beam constraint, “1” indicates that a group of beams indicated by the lowest tag in a beam index is constrained, and “2” indicates that a group of beams indicated by the second lowest tag in the beam index is constrained, and so on. In other embodiments, when indicating a beam constraint, “0” indicates that there is no beam constraint, and “1” indicates that a group of beams indicated by a tag with “x” in the beam index is constrained.

Granularity of the bitmap may be a frequency-domain physical resource block, sub-band, broadband or carrier, and/or a time-domain sub-frame. If the granularity is a sub-band, the size of the sub-band may be defined to be the same as that in a CSI report, or is specifically defined as 2PRB, 5PRB, 6PRB or the like. If multiple bitmaps are that different beam constraints indicate the same time-frequency resource, all beams indicated on the resource are constrained. Similarly, if multiple bitmaps are that different beam permissions indicate the same time-frequency resource, all beams indicated on the resource are permitted.

Power Domain

A power indicator indicates that transmit power of the first transmission point 200 is reduced to a certain threshold in selected PRBs. In some embodiments, the power indicator may be one or more transmit power thresholds. The transmit power thresholds can be specifically defined, for example, 20/24/30/37 dBm or be differentially defined, for example, lower than a power level of 4 dB/2 dB/0 dB signaled by a CSI process configuration. The transmit power thresholds can also be roughly defined, for example, zero/low/medium/all, where “low” means that if the first transmission point 200 uses a beam signaled by a beam indicator, low transmit power should be used in some RPBs, while “all” means that if the second transmission point 102 uses a beam signaled by the beam indicator, all transmit power can be used for transmission.

The specific transmission manner of the power indicator is similar to that of the beam indicator, which is also sent through a power index list and a corresponding bitmap, and is not repeated herein.

UE Scheduling

A UE scheduling indicator indicates that the first transmission point permits or avoids scheduling of some selected UEs on selected PRBs/sub-frames. For each PRB/sub-frame having a scheduling resolution constraint of the first transmission point, the scheduling indicator may indicate a cell identifier of the strongest interference source in terms of the UE of the first transmission point 200. The indication granularity may be a PRB level, a PRB group level, a sub-band level, a broadband level, a sub-frame level and/or a carrier level. If the granularity is a sub-band, the size of the sub-band may be defined to be the same as that in a CSI report, or is specifically defined as 2PRB, 5PRB, 6PRB or the like.

The specific transmission manner of the UE scheduling indicator is similar to that of the beam indicator, which is also sent through a UE scheduling index list and a corresponding bitmap, and is not repeated herein.

Frequency Domain

X2 signaling granularity in a frequency domain according to the present invention is defined as the size of the sub-band for information exchange.

The finest X2 signaling granularity is each PRB. However, in consideration of CSI feedback granularity, limited circuit capacity, and limited accuracy of interference estimation at the first transmission point 200, the X2 signaling granularity in the frequency domain may be a sub-band or other sizes indicated by the X2 signaling. In partial embodiments, the signaling information is compressed by using a large sub-band size for information exchange. Within each grid of the frequency domain, the X2 signaling may include one or more combinations, which may include one beam indicator as described above, one power threshold as described above and/or the UE scheduling as described above.

Time Domain

The X2 signaling according to partial embodiments of the present invention may include an information reliability timer.

In consideration of channel coherence time and scheduling of the first transmission point 200, the beam, the power, the UE scheduling, and information transmitted by X2 signaling information given in the frequency domain may be effective in limited sub-frames, that is, non-periodic. Before next X2 signaling is updated, due to the nonoptimal circuit, the update may not occur or be delayed severely. The timer provides a time window, and during the time window, the second transmission point 202 may consider such type of X2 signaling. If the time runs out, the second transmission point 202 may completely ignore the information, which may be ineffective.

The beam, the power, the UE scheduling, and the information in the frequency domain are also associated with sub-sets of sub-frames for constraints in the time domain, that is, periodic. For example, some selected sub-frames, from the perspective of the first transmission point 200, should be protected or be limited to be used along with the improved X2 signaling according to the present invention.

The above indications about resource allocation are about the first transmission point; however, in some embodiments of the present invention, the first transmission point 200 may also notify the second transmission point 202 of resource allocation of neighboring cells of the first transmission point 200 to reduce transmission delays. In a centralized control mode, the resource allocation of the neighboring cells includes resource allocation of the second transmission point 202. According to partial embodiments of the present invention, the first transmission point 200 may be a central node, which may collect all information about cooperative cells, for example, a CSI report of each cell. From the perspective of signaling, this does not affect whether the first transmission point has a centralization function or is a real cell.

In addition to signaling sent from the first transmission point 200 to the second transmission point 202, partial embodiments of the present invention further provide signaling sent from the second transmission point 202 to the first transmission point 200. The definition about resource usage information in the part also applies to the part of the signaling sent from the first transmission point 200 to the second transmission point 202.

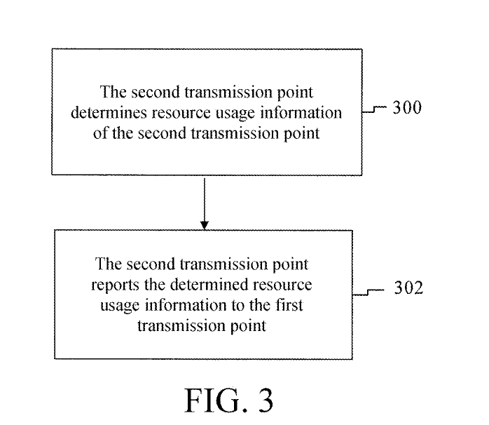

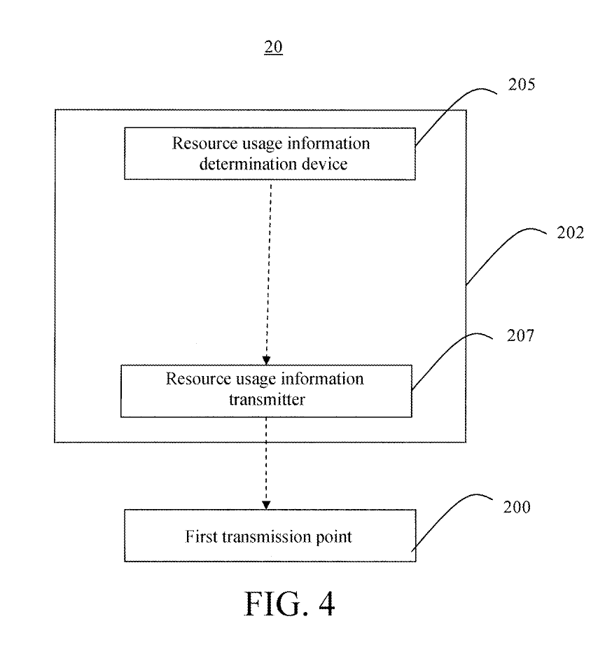

FIG. 3 is a flow chart of a method for exchanging signaling information in CoMP according to another embodiment of the present invention. FIG. 4 is a schematic structural diagram of the system 20 for exchanging signaling information in CoMP according to another embodiment of the present invention, where an apparatus 202 may be the second transmission point or be arranged on the second transmission point. In this embodiment, it is set that the apparatus 202 is the same as the second transmission point.

As shown in FIG. 3 and FIG. 4, the method includes: In step 300, the apparatus 202, that is, a resource allocation determination device 205 of the second transmission point 202, determines resource allocation for at least one of the first transmission point 200 and the second transmission point 202, the resource allocation including at least one of beamforming, power, and UE scheduling of the corresponding transmission point. In step 302, a resource allocation transmitter 207 of the apparatus 202 notifies the second transmission point 202 of the determined resource allocation.

According to partial embodiments of the present invention, for example, the second transmission point 202 is strongly interfered with by the first transmission point 200, and can report resource usage information of the second transmission point 202 to the first transmission point 200 to request the first transmission point 200 to adjust resource allocation or broadcast the information to all neighboring cells. In addition to the resource usage information, the second transmission point 202 may also choose to send level information of interference on the second transmission point 202 to the first transmission point 200.

After receiving the information sent by the second transmission point 202, the first transmission point 200 may choose to collect required information such as resource usage information of neighboring cells. In partial embodiments, the first transmission point 200 may also collect level information of interference of the neighboring cells.

Based on the collected information, the first transmission point may adjust or not adjust the resource allocation of the first transmission point.

In partial embodiments of the present invention, the resource usage information reported by the second transmission point 202 includes: usage information about resources protected by the first transmission point 200, usage information about resources not protected by the first transmission point 200, usage information about resources protected by other neighboring cells, and usage information about resources not protected by the other neighboring cells. The protected resources represent resources constrained in the spatial domain, the power domain, and the UE scheduling, while the unprotected resources represent resources not constrained in the spatial domain, the power domain, and the UE scheduling. For example, for the second transmission point 202, the first transmission point 200 reduces the power of the first transmission point 200 to a certain threshold to reduce the interference of the first transmission point 200 on the second transmission point 202, and resources of the power are protected resources.

The second transmission point 202 may report resource usage information of the second transmission point 202 or level information of interference periodically or in an event-triggered manner. In the case of periodic reporting, a time cycle may be set to 1 s, 2 s, 5 s, 10 s or the like. In addition, in partial embodiments, the reported resource usage information may be sub-classified according to multiple TPs, for example, usage information of resources protected by the first transmission point and the second transmission point simultaneously.

The determination of the resource usage information may take into account a buffer status, current resource usage, expected resource usage, service priority and other information. In power allocation, resource usage may be related to long-term channel information and/or a current interference level of a corresponding UE. For example, usage of the protected resources may correspond to UEs requiring such protection.

According to partial embodiments of the present invention, the resource usage information may be classified into:

1) usage of downlink PEBs of protected resources or usage of downlink PEBs of protected resources for protected UEs

2) usage of downlink PEBs of unprotected resources for the protected UEs

3) usage of uplink PEBs of the protected resources or usage of uplink PEBs of the protected resources for the protected UEs

4) usage of uplink PEBs of the unprotected resources for the protected UEs.

The resource usage information defined in the embodiments of the present invention is calculated based on the resource usage information definition in the TS36.314 standards. PRB usage values of the protected resources in partial embodiments of the present invention are integers between (0 . . . 100). PRB usage is based on the resource protection type, measurement of PRB usage is a set of protected UEs having the same resource protection type within one cell, and uplinks and downlinks are measured separately. Partial embodiments of the present invention provide the following calculation formula:

$$M ( T ) = ⌊ \frac{M 2 ( T )}{P ( T )} * 100 ⌋$$

where,

M(T) denotes PRB usage of protected resources of a resource protection type, and is expressed as an average percentage of PRB usage within a time cycle T, and the value of M(T) is in a range of 0 to 100%;

M2(T) denotes the number of all PRBs of protected UEs of the corresponding resource protection type, for downlinks, all PRBs for corresponding transmission should be included, while for uplinks, all PRBs allocated to corresponding transmission should be included; and

P(T) denotes the total number of available PRBs within the time cycle T. In other embodiments, P(T) may also be defined as the total number of used PRBs.

Similar to PRB usage of the protected resources, PRB usage values of unprotected resources in partial embodiments of the present invention may also be defined as integers between (0 . . . 100). Based on a desired resource protection type, measurement of PRB usage is a set of all protected UEs that have the resource protection type within one cell but use resources not protected by the type, and uplinks and downlinks are measured separately. Reference can be made to the above measurement formula of the PRB usage of the protected resources for a specific measurement formula, which is not repeated herein.

According to partial embodiments of the present invention, the resource usage information can be defined and classified according to central UEs in a cell, that is, unprotected UEs. In some other embodiments of the present invention, the resource usage information can be defined and classified according to sub-frame usage instead of PRB usage. For the sub-frame usage, the value of sub-frame usage may also be an integer, for example, (0 . . . 40) or (0 . . . 8) or the like.

In addition, when the second transmission point 202 reports an interference level to the first transmission point 200, the interference level may be roughly classified into low, medium, and high. The interference level is indicated with protected resources or unprotected resources.

In some embodiments, if the interference level is indicated with protected resources, it is recommended that interference power should be further reduced or it is recommended that multiple beams should become blanking in particular resources.

According to partial embodiments of the present invention, the first transmission point 200 may be a central node, which can collect information of all cooperative cells, for example, a CSI report of each cell, so that that the notification of resource allocation is transmitted from the first transmission point 200 to the second transmission point 202. From the perspective of signaling, this does not affect whether the first transmission point has a centralization function or is a real cell.

In addition, although some embodiments of the present invention only demonstrate simple CoMP involving a first transmission point and a second transmission point, persons skilled in the art should fully understand how to apply the improved X2 signaling of the present invention to a complex CoMP system with teachings and inspirations of the present invention.

It should be noted that, due to development of technologies and update of standards, components having the same function often have many different names. Technical terms used in the patent application of the present invention are intended to explain and demonstrate the technical solution of the present invention, should be subject to consensus-based functions in the technical field, but cannot be arbitrarily interpreted only with similarities and differences of names.

The technical content and technical features of the present invention are disclosed above, and persons skilled in the art may still make various replacements and modifications without departing from the spirit of the present invention on the basis of the teaching and disclosure of the present invention. Hence, the protection scope of the present invention shall not be limited to the content disclosed by the embodiments, but shall cover all replacements and modifications that do not depart from the present invention and shall subject to the claims of the present patent application.

1. A method for exchange of signaling information in coordinated multi-point (CoMP), wherein a first transmission point and a second transmission point provide CoMP for at least one user equipment (UE), the method comprising:
the first transmission point determining resource allocation for at least one of the first transmission point and the second transmission point, the resource allocation comprising at least one of beamforming, power, and UE scheduling of the corresponding transmission point; and
the first transmission point notifying the second transmission point of the determined resource allocation.

2. The method according to claim 1, further comprising: the first transmission point notifying the second transmission point of resource allocation for the other transmission point.

3. The method according to claim 1, wherein the first transmission point uses an indicator of a different type of resource to notify allocation information for the type of resource, the indicator of the different type of resource comprising an index list of the corresponding type of resource and a corresponding bitmap.

4. The method according to claim 3, wherein granularity of the bitmap is a frequency-domain physical resource block, sub-band, broadband or carrier, and/or a time-domain sub-frame.

5. The method according to claim 3, wherein the value of each position in the corresponding bitmap is a tag of indexes of one group of the type of resources in the index list of the corresponding type of resource.

6. The method according to claim 3, wherein beam information corresponds to each basic unit in a corresponding beam index list, which is related to a precoding matrix indicator (PMI), a rank indicator (RI), and a beam tag, and/or related to multiple PMI-RI pairs and a beam tag.

7. The method according to claim 3, wherein each beam indicator in a beam index list comprises at least one beam constraint or beam permission.

8.-13. (canceled)

14. A method for exchange of signaling information in coordinated multi-point (CoMP), wherein a first transmission point and a second transmission point provide CoMP for at least one user equipment (UE), the method comprising:
the second transmission point determining resource usage information of the second transmission point; and
the second transmission point reporting the determined resource usage information to the first transmission point.

15. The method according to claim 14, further comprising: the second transmission point reporting level information of interference on the second transmission point to the first transmission point.

16. The method according to claim 14, wherein the resource usage information comprises: usage information about resources protected by the first transmission point, usage information about resources not protected by the first transmission point, usage information about resources protected by other neighboring cells, and usage information about resources not protected by the other neighboring cells.

17. The method according to claim 14, wherein the second transmission point reports the resource usage information periodically or in an event-triggered manner.

18. The method according to claim 14, wherein the resource usage information is classified into: usage of downlink physical resource blocks of protected resources for protected UEs, usage of downlink physical resource blocks of unprotected resources for the protected UEs, usage of uplink physical resource blocks of the protected resources for the protected UEs, and usage of uplink physical resource blocks of the unprotected resources for the protected UEs.

19. An apparatus for exchange of signaling information in coordinated multi-point (CoMP), wherein a first transmission point and a second transmission point provide CoMP for at least one user equipment (UE); and the apparatus is arranged on the first transmission point, and comprises:
a resource allocation determination device that determines resource allocation for at least one of the first transmission point and the second transmission point, the resource allocation comprising at least one of beamforming, power, and UE scheduling of the corresponding transmission point; and
a resource allocation transmitter that notifies the second transmission point of the determined resource allocation.

20.-23. (canceled)

24. An apparatus for exchange of signaling information in coordinated multi-point (CoMP), wherein a first transmission point and a second transmission point provide CoMP for at least one user equipment (UE); and the apparatus is arranged on the second transmission point, and comprises:
a resource usage information determination device that determines resource usage information of the second transmission point; and
a resource usage information transmitter that reports the determined resource usage information to the first transmission point.

25.-27. (canceled)

28. A method for exchange of signaling information in coordinated multi-point (CoMP), wherein a first transmission point and a second transmission point provide CoMP for at least one user equipment (UE), the method comprising:
the first transmission point receiving resource usage information about the second transmission point reported by the second transmission point;
based on the received resource usage information, the first transmission point determining resource allocation for at least one of the first transmission point and the second transmission point, the resource allocation comprising at least one of beamforming, power, and UE scheduling of the corresponding transmission point; and
the first transmission point notifying the second transmission point of the determined resource allocation.
